(19) United States
(12) Patent Application Publication
(10) Pub. No.: US 2025/0341707 A1
(43) Pub. Date: Nov. 6, 2025

(54) PROJECTOR DEVICE

(71) Applicant: SAMSUNG ELECTRONICS CO., LTD., Suwon-si (KR)

(72) Inventor: Wonyong LEE, Suwon-si (KR)

(73) Assignee: SAMSUNG ELECTRONICS CO., LTD., Suwon-si (KR)

(21) Appl. No.: 19/266,949

(22) Filed: Jul. 11, 2025

Related U.S. Application Data
(63) Continuation of application No. PCT/KR2024/000684, filed on Jan. 15, 2024.

(30) Foreign Application Priority Data
Mar. 2, 2023 (KR) 10-223-0027972

(51) Int. Cl. G02B 13/16; G02B 1/11; G02B 3/00; G03B 21/00; G03B 21/28

(52) U.S. Cl. CPC G02B 13/16; G02B 1/11; G02B 3/0087; G02B 2003/0093; G02B 2207/101; G03B 21/008; G03B 21/28

(57) ABSTRACT

A projector device includes: an optical module; an exterior case including the optical module; and a cover glass configured to transmit light incident from the optical module, where the cover glass includes: a transparent layer including a transparent material; and a refractive index buffer layer on at least one surface of the transparent layer, and where a refractive index of the refractive index buffer layer changes with respect to a vertical direction.

### CROSS-REFERENCE TO RELATED APPLICATION(S)

This application is a continuation of International Application No. PCT/KR2024/000684, filed on Jan. 15, 2024, in the Korean Intellectual Property Receiving Office, which is based on and claims priority to Korean Patent Application No. 10-2023-0027972, filed on Mar. 2, 2023, in the Korean Intellectual Property Office, the disclosures of which are incorporated by reference herein in their entireties.

### BACKGROUND

### 1. Field

The disclosure relates to a projector device, and more particularly to an ultra-short throw projector device.

### 2. Description of Related Art

With developments in electronic technology, electronic devices of various types are being developed and supplied. Specifically, electronic devices used in various locations such as homes, offices, public spaces, and the like have been developed continuously during recent years.

Specifically, projector devices which project an image to a screen are being developed into various forms. Recently, ultra-short throw projector devices which project an image to a screen from a short distance are being supplied.

### SUMMARY

Aspects will be set forth in part in the description which follows and, in part, will be apparent from the description, or may be learned by practice of the presented embodiments.

According to an aspect of the disclosure, a projector device may include: an optical module; an exterior case including the optical module; and a cover glass configured to transmit light incident from the optical module, where the cover glass includes: a transparent layer including a transparent material; and a refractive index buffer layer on at least one surface of the transparent layer, and where a refractive index of the refractive index buffer layer changes with respect to a vertical direction.

The refractive index buffer layer may include a nanopattern that increases in density from a first surface to a second surface, where the refractive index of the refractive index buffer layer consecutively changes from the first surface to the second surface.

The projector device of claim 2, where a total cross-sectional area of the nanopattern is increased moving from the first surface to the second surface.

The nanopattern may include a triangular pyramid shape or a square pyramid shape in which a vertex is at the first surface and a bottom surface is at the second surface.

The nanopattern may include a conical shape in which a vertex is at the first surface and the bottom surface is at the second surface, or the nanopattern may include a step shape in which a width of a cross-section is increased from the first surface to the second surface.

The refractive index buffer layer may be on a surface of the transparent layer on which light is incident from the optical module, where the nanopattern increases in density from the first surface on which the light is incident to the second surface from which the incident light is output.

The cover glass may further include: a coating layer on a second surface of the transparent layer, where the coating layer is an anti-reflection (AR) optical coating layer.

The refractive index buffer layer may include: a first refractive index buffer layer on a first surface of the transparent layer; and a second refractive index buffer layer on a second surface of the transparent layer, where the first refractive index buffer layer includes the nanopattern that increases in density from a first surface on which the light is incident to a second surface from which the incident light is output, and where the second refractive index buffer layer includes a nanopattern that decreases in density from a first surface that is adjacent to the second surface of the transparent layer to a second surface from which the light is output.

The projector device may include an ultra-short throw projector device in which an angle of light incident to the cover glass is greater than or equal to a threshold angle.

The cover glass may be at a side of the optical module to which light from the optical module is output, where an opening is provided at a side of the exterior case corresponding to the side of the optical module provided with the cover glass.

The cover glass may be parallel to the side of the exterior case.

The cover glass may be parallel to a side of the exterior case corresponding to an area to which light from the optical module is output, where an opening is provided at a side of the optical module corresponding to the side of the exterior case provided with the cover glass.

The cover glass may include: a first cover glass provided at a side of the optical module; and a second cover glass provided at a side of the exterior case corresponding to the side of the optical module.

The first cover glass and the second cover glass may be parallel to each other, where the second cover glass is at a position offset by a pre-set distance based on the first cover glass from the side of the exterior case.

The optical module may include: a light panel including micromirrors integrated thereon; a lens configured to refract and transmit light output from the light panel; and an aspheric mirror configured to reflect the light refracted through the lens in a direction of the cover glass.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a structure and an operation of a projector device according to one or more embodiments;

FIG. 2A and FIG. 2B are diagrams illustrating a light reflection and refraction phenomenon according to one or more embodiments;

FIG. 3 is a diagram illustrating a structure and an operation of a projector device according to one or more embodiments;

FIG. 4 is a diagram illustrating a structure and an operation of a projector device according to one or more embodiments;

FIG. 5 is a diagram illustrating an implementation example of a cover glass according to one or more embodiments;

FIG. 6A, FIG. 6B, FIG. 6C, FIG. 6D, and FIG. 6E are diagrams illustrating various implementation examples of a cover glass according to one or more embodiments;

FIG. 7A, FIG. 7B, FIG. 7C, and FIG. 7D are diagrams illustrating implementation examples of a refractive index buffer layer according to one or more embodiments;

FIG. 8 is a diagram illustrating a reflectance improvement effect of a refractive index buffer layer according to one or more embodiments; and

FIG. 9A and FIG. 9B are diagrams illustrating an arrangement form of a cover glass according to one or more embodiments.

### DETAILED DESCRIPTION

The disclosure will be described in greater detail below with reference to the accompanied drawings.

Terms used in the disclosure will be briefly described, and the disclosure will be described in detail.

The terms used in the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have”, “may have”, “include”, “may include”, “comprise”, “may comprise” and the like, are used to designate a presence of a corresponding characteristic (e.g., elements such as numerical value, function, operation, or component), and not to preclude a presence or a possibility of additional characteristics.

The expression at least one of A and/or B is to be understood as indicating any one of “only A” or “only B” or “both A and B”.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with a hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor (not shown).

One or more embodiments of the disclosure will be described in detail below with reference to the accompanied drawings.

An embodiment of the disclosure will be described in greater detail below with reference to the accompanied drawings.

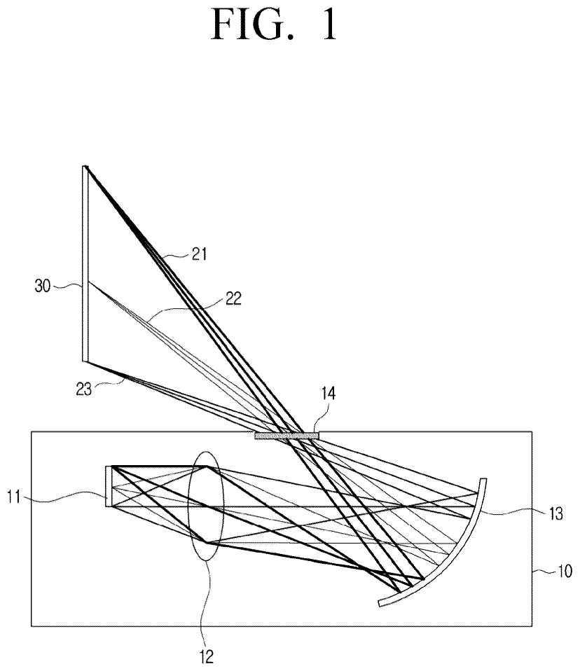

FIG. 1 is a diagram illustrating a structure and an operation of a projector device according to one or more embodiments.

According to one or more embodiments, the projector device may include an optical module 10 as shown in FIG. 1. According to an example, the projector device may be implemented as a digital light processing (DLP) projector.

According to an example, the optical module 10 may include a light panel 11, a lens 12, and an aspheric mirror 13. According to an example, the optical module 10 may further include a cover glass 14 as shown in FIG. 1. However, although the cover glass 14 may be provided at an exterior case rather than the optical module 10, for convenience of description in FIG. 1, the cover glass 14 being provided in the optical module 10 may be described.

The light panel 11 may be implemented in a form in which micromirrors are integrated. The light panel 11 may implement an image by processing (e.g., mixing and generating color) light emitted from a light source lamp. For example, light emitted from the light source lamp may be reflected by the light panel 11 after passing a color wheel alternately. According to an example, the light panel 11 may be implemented as a digital micromirror device (DMD) panel. For example, a countless number of micromirrors compactedly embedded on a surface of the DMD panel may form a screen by repeatedly turning on and turning off at a very fast speed.

The lens 12 may be implemented to refract and transmit light output from the light panel 11.

The aspheric mirror 13 may be implemented to reflect refracted light in a direction of the cover glass 14 through the lens 12.

The cover glass 14 may be implemented to transmit light reflected through the aspheric mirror 13. Light 21, 22, and 23 transmitted through the cover glass 14 may be projected to a screen 30 and display an image. The cover glass 14 may be used to prevent contamination of a light component or to improve product design.

According to an example, the cover glass 14 may include a transparent layer implemented with a transparent material. For example, the transparent layer may be implemented with a transparent glass or a transparent plastic.

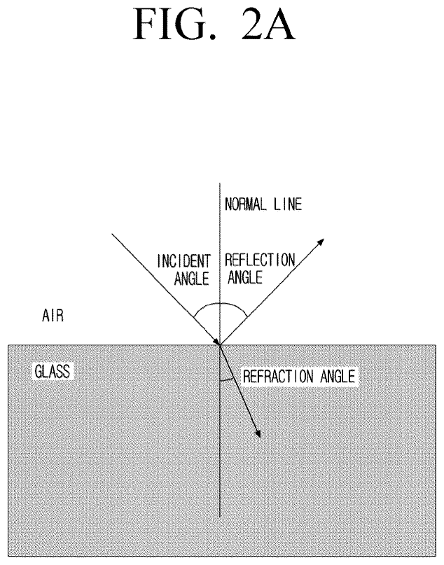

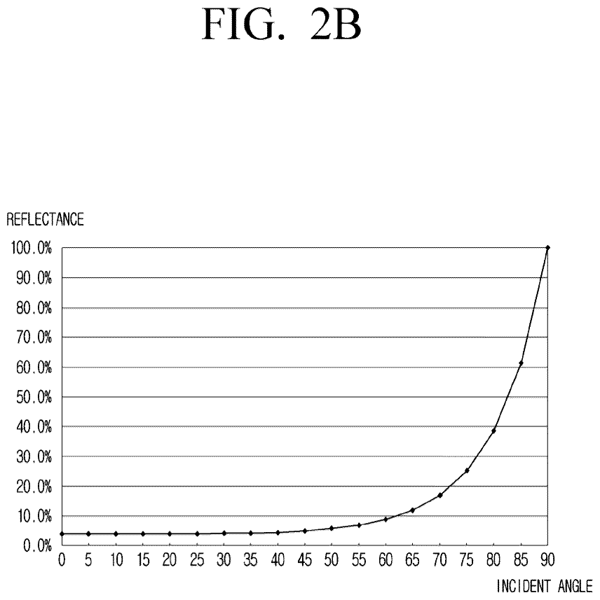

FIG. 2A and FIG. 2B are diagrams illustrating a light reflection and refraction phenomenon.

As shown in FIG. 2A, light may show a reflection and refraction phenomenon at a boundary of media, for example, a glass. A line perpendicular to the surface of the glass may be referred to as a normal line, an angle by which an incident beam forms with the normal line may be referred to as an incident angle, an angle of an output beam may be referred to as an output angle, and an angle of a refraction beam may be referred to as a refraction angle. In this case, reflectance may depend on the refractive index and the incident angle, and reflectance may become higher as the refractive index is greater and the incident angle is greater.

FIG. 2B is a graph illustrating reflectance for a medium with a refractive index of 1.5. Referring to FIG. 2B, it can be verified that there is little change in reflectance at an incident angle of about 40 degrees, and that there is a significant increase in reflectance as the incident angle exceeds 60 degrees. In an example, reflectance at an incident angle of 0 degrees at one surface of a glass with a refractive index of 1.5 is 4%, whereas reflectance at an incident angle of 80 degrees is 38.8%. Because reflection in glass occurs at both surfaces, reflection at a large incident angle may increase even more.

If the projector device is an ultra-short throw projector device, the incident angle of light reflected from the aspheric mirror 13 and incident on the cover glass 14 may become greater due to light being projected to a large screen from a short distance. Accordingly, if implemented as shown in FIG. 1, the incident angle incident on the cover glass 14 may become significantly greater from incident beam 23 compared to incident beam 21, and because light arriving at the screen 30 is significantly reduced due to reflectance of incident beam 23 on the cover glass 14 being high, uniformity in brightness of the screen may be significantly deteriorated.

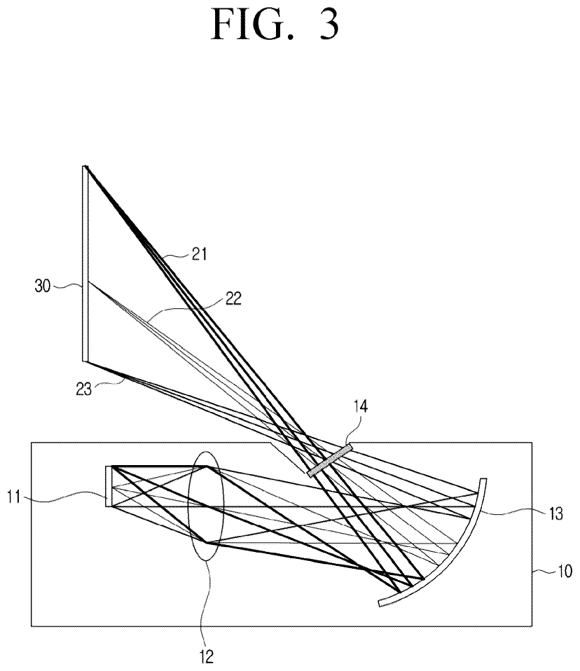

To solve the above-described problem, in the case of the ultra-short throw projector device, a method of reducing incident angle of incident beam 23 may be used by installing the cover glass 14 at a tilt as shown in FIG. 3. In this case, because of the cover glass 14 is installed at a tilt, a product may have a deeply recessed shape and this shape is referred to as a valley type. When the cover glass 14 is installed as the valley type as described above, there is a problem of an exterior shape of the product being not appealing and restricting a product design.

Accordingly, one or more embodiments in which uniformity in brightness of the projector device is improved and product design is differentiated while the tilt of the cover glass is minimized by increasing transmittance of light incident on the cover glass at a large incident angle will be described below.

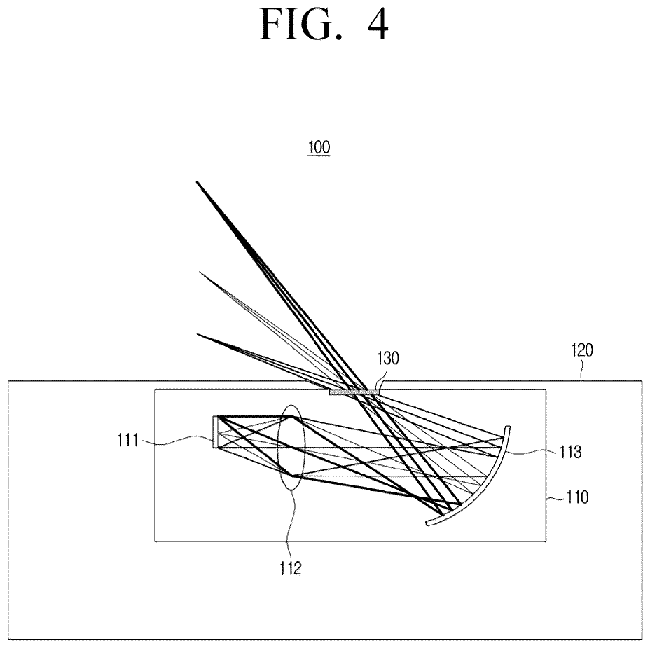

FIG. 4 is a diagram illustrating a structure and an operation of a projector device according to one or more embodiments.

Referring to FIG. 4, a projector device 100 may include an optical module 110, an exterior case 120, and a cover glass 130.

According to one or more embodiments, the projector device 100 may be implemented as the ultra-short throw projector device which projects an image to the screen from a short distance. When the projector device 100 is implemented as the ultra-short throw projector device, an angle of light incident on the cover glass 130 may be greater than or equal to a threshold angle. For example, the threshold angle may be 70 degrees, but is not limited thereto.

Accordingly, the projector device 100 may be implemented as a digital light processing (DLP) projector. However, the embodiment is not limited thereto, and may be implemented as other types of projector devices which use a cover glass.

The optical module 110 may include a light panel 111, a lens 112, and an aspheric mirror 113. The exterior case 120 may be implemented so as to form an exterior that covers the optical module 110.

The light panel 111 may be implemented in a form in which micromirrors are integrated. The light panel 111 may implement an image by processing (e.g., mixing and generating color) light emitted from the light source lamp. For example, light emitted from the light source lamp may be reflected by the light panel 111 after passing the color wheel alternately. According to an example, the light panel 111 may be implemented as a digital micromirror device (DMD) panel which is a semiconductor light switch panel in which micro driving mirrors are integrated.

Specifically, the DMD may be a semiconductor light switch in which micro driving mirrors are integrated, and each aluminum alloy micromirror of 16 μm size formed at an upper portion for each 1 cell of a static random access memory (SRAM) may have a tilt of ±10° for each on/off state. Micromirrors installed at posts may operate by electrostatic action of a memory arranged directly at a lower portion. As a person is able to see a degree of brightness corresponding to an accumulated value of time by adjusting time that light projected by the micromirrors is reflected and emitted or not reflected, brightness/darkness for each pixel in the screen may be expressed. For example, there may be two types such as a single-plate type and a three-plate type. In the case of the single-plate type, because a circular plate mounted with an R, G, B filter is placed between a light source and micromirrors, a device may show an effect of a three-color light source by processing images corresponding to each of R, G, and B at a timing each of the R, G, and B are shown. While the single-plate type shows a deterioration in light efficiency due to R, G, and B on a time axis dividing and using time respectively as described, the three-plate type shows an advantage of superior light efficiency due to selecting a method of also separating each of R, G, and B light from one light source and providing light to each of the devices that manage three colors. A switching speed of each mirror may be greater than or equal to 500k times per second, and light incident to a tip may be digitally controlled.

The lens 112 may be implemented to refract and transmit light output from the light panel 111.

The aspheric mirror 113 may be implemented to reflect light refracted through the lens 112 in a direction of the cover glass 130.

The cover glass 130 may be implemented to transmit the light reflected through the aspheric mirror 113. The light transmitted through the cover glass 130 may be projected to the screen and display an image. According to an example, the cover glass 130 may include a transparent layer implemented with a transparent material. For example, the transparent layer may be implemented with a transparent glass or a transparent plastic.

According to one or more embodiments, the cover glass 130 may be provided in parallel with one side of the exterior case 120.

According to one or more embodiments, the cover glass 130 may be provided at one side of the optical module 110 to which light is output from the optical module 110. In this case, at one side of the exterior case 120 corresponding to one side of the optical module 110 provided with the cover glass 130, an opening may be provided.

According to one or more embodiments, the cover glass 130 may be provided at one side of the exterior case 120 corresponding to an area at which light is output from the optical module 110. In this case, at one side of the optical module 110 corresponding to one side of the exterior case 120 provided with the cover glass 130, an opening may be provided.

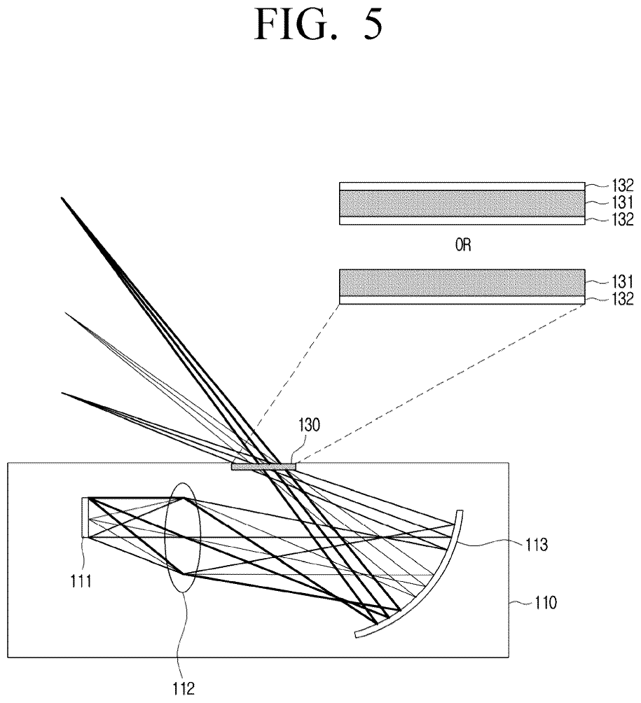

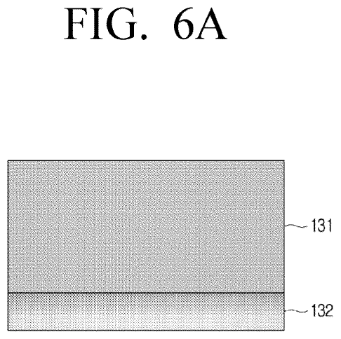

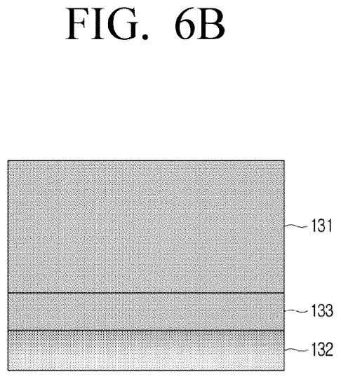

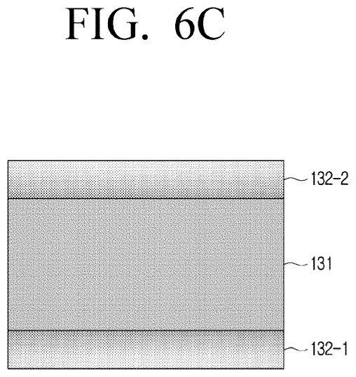

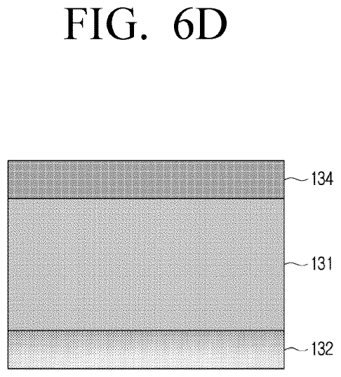

FIG. 5 is a diagram illustrating an implementation example of a cover glass according to one or more embodiments.

According to one or more embodiments, the cover glass 130 may include a transparent layer 131 and a refractive index buffer layer 132. According to an example, the refractive index buffer layer 132 may be provided on at least one surface of the transparent layer 131. For example, as shown in FIG. 5, the refractive index buffer layer 132 may be provided on one surface of the transparent layer 131, or provided each of both surfaces of the transparent layer 131. Here, the refractive index buffer layer 132 may be a layer implemented for the refractive index to be consecutively changed in a vertical direction. In this case, a film layer may be or may not be provided between the transparent layer 131 and the refractive index buffer layer 132. Typically, reflectance of light may be affected by a difference in refractive index from a boundary surface of a medium and an incident angle. Accordingly, reflectance may be lowered if the difference in refractive index from the boundary surface is lowered. Based on this principle, the refractive index buffer layer 132 for reducing reflectance may be provided at the cover glass 130.

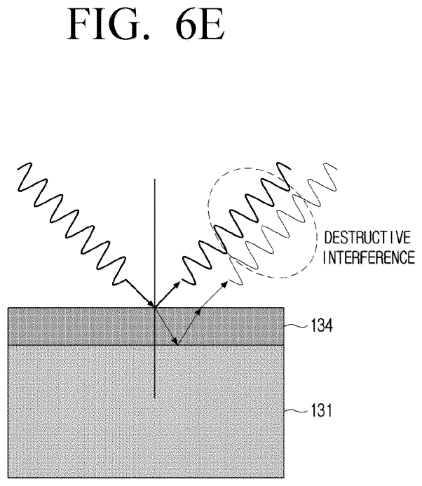

FIG. 6A to FIG. 6E are diagrams illustrating various implementation examples of a cover glass.

According to one or more embodiments, the refractive index buffer layer 132 may be attached to the transparent layer 131 by being produced by directly processing the transparent layer 131 or being produced in a separate film form. For example, the refractive index buffer layer 132 may be implemented with the same material as the transparent layer 131, or implemented with a separate material (e.g., a UV resin).

According to an example, the refractive index buffer layer 132 may have a refractive index value that is changed in the vertical direction. For example, the refractive index buffer layer 132 may have a refractive index value that is consecutively changed in the vertical direction and thereby, surface reflection may be minimized.

According to one or more embodiments, as shown in FIG. 6A, the refractive index buffer layer 132 may be provided at one surface of the transparent layer 131.

According to one or more embodiments, as shown in FIG. 6B, the refractive index buffer layer 132 may be provided at one surface of the transparent layer 131 and a film layer 133 may be provided between the refractive index buffer layer 132 and the transparent layer 131. Here, the film layer 133 may be implemented as a substrate film.

According to one or more embodiments, as shown in FIG. 6C, the refractive index buffer layers 132-1 and 132-2 may be provided on both surfaces of the transparent layer 131.

For example, the refractive index buffer layer 132 may include a first refractive index buffer layer 132-1 provided at one surface of the transparent layer 131 and a second refractive index buffer layer 132-2 provided at other surface of the transparent layer 131. Alternatively, although not shown in FIG. 6C, the film layer 133 may be provided between the first refractive index buffer layer 132-1 and the transparent layer 131, and between the second refractive index buffer layer 132-2 and the transparent layer 131.

According to one or more embodiments, as shown in FIG. 6D, at one surface (a surface facing an inner side of the optical module 110) of the transparent layer 131, the refractive index buffer layer 132 may be provided, and at the other surface (a surface exposed to the outside of the cover glass 130) of the transparent layer 131, a coating layer 134 may be provided.

Alternatively, the film layer 133 may be provided between the transparent layer 131 and the refractive index buffer layer 132, and the film layer 133 may be provided between the transparent layer 131 and the coating layer 134. For example, the coating layer 134 may include an anti-reflection (AR) optical coating layer. As shown in FIG. 6E, the anti-reflection (AR) optical coating layer may be implemented so as to use a destructive interference phenomenon of light by repeatedly coating a low refractive index material and a high refractive index material in order to lower reflectance. When implemented as shown in FIG. 6D, the surface exposed to the outside may have a strong effect against scratches or contamination through the coating layer 134 and may lower reflectance through the refractive index buffer layer 132.

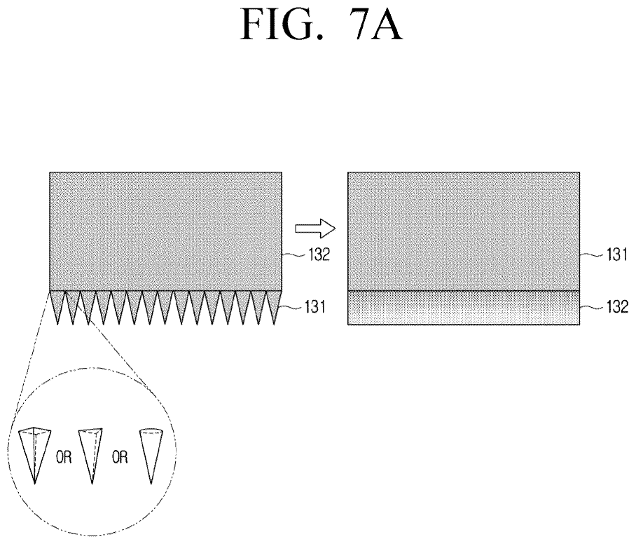

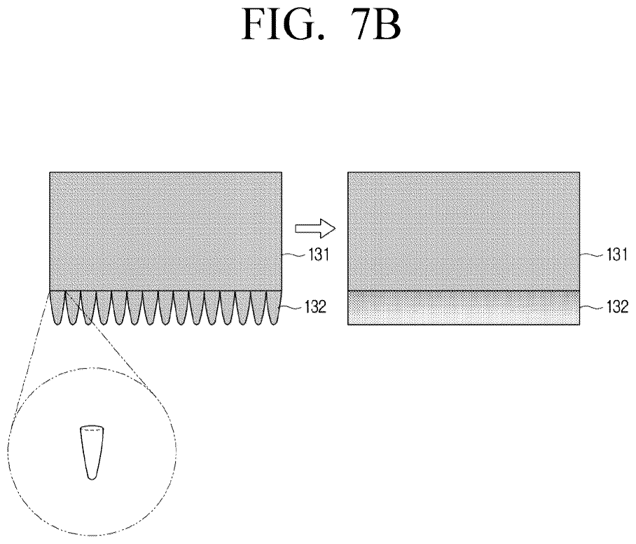

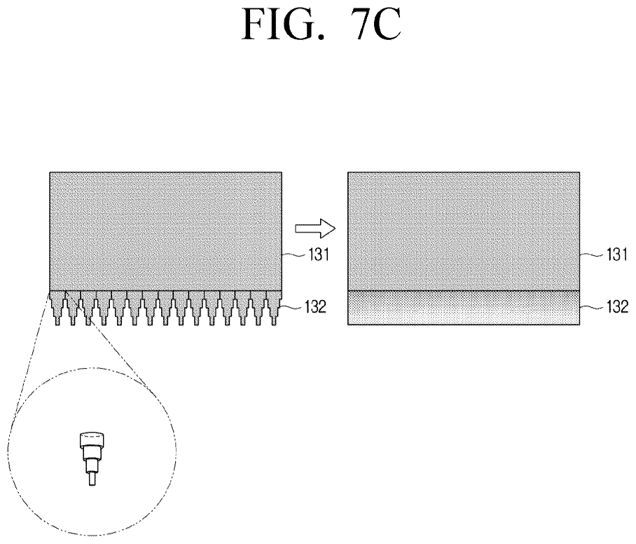

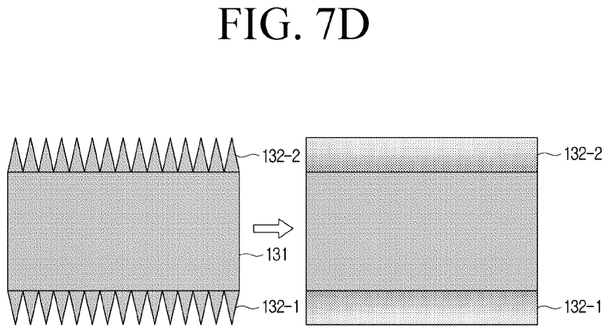

FIG. 7A to FIG. 7D are diagrams illustrating implementation examples of a refractive index buffer layer according to one or more embodiments.

According to one or more embodiments, the refractive index buffer layer 132 may be implemented with a nanopattern structure that increases in density moving from one surface to other surface. Here, the one surface may be a surface on which light is incident from the optical module 110. For example, the refractive index buffer layer 132 may be implemented with a nanopattern that increases in density moving from one surface on which light is incident to other surface from which the incident light is output. The refractive index buffer layer 132 may be implemented so as to consecutively change material density using the nanopattern. For example, when a nanopattern having an interval of less than or equal to a light wavelength is used, an effect of a refractive index of light consecutively changing may be implemented. The method as described may minimize reflectance on a boundary surface because difference between air and refractive index on the boundary surface can be minimized.

According to one or more examples, the refractive index buffer layer 132 may be provided on one surface of the transparent layer 131 on which light from the optical module 110 is incident. In this case, the refractive index buffer layer 132 may be implemented with a nanopattern that increases in density moving from one surface on which light is incident to other surface from which the incident light is output. For example, the nanopattern may be implemented with a nanopattern in which a total cross-sectional area is increased moving from one surface to other surface.

FIG. 7A is a diagram illustrating an implementation example of the refractive index buffer layer 132 using a nanopattern according to one or more embodiments.

For example, the nanopattern may be implemented with a nanopattern that forms a vertex from one surface and forms a bottom surface of a pre-set shape from other surface. Here, the bottom surface of the pre-set shape may include at least one from among a triangle, a quadrangle, or a circle. Accordingly, the nanopattern may be implemented as at least one from among a triangular pyramid, a quadrangular pyramid, or a cone. Reflectance from the refractive index buffer layer using the nanopatterns described above may be able to implement a low reflectance at not just a small incident angle, but also a large incident angle.

FIG. 7B is a diagram illustrating an implementation example of the refractive index buffer layer 132 using a nanopattern according to one or more embodiments.

For example, the nanopattern may be implemented with a nanopattern that forms a vertex from one surface and forms a bottom surface of a pre-set shape from other surface. As shown in FIG. 7B, the bottom surface of the pre-set shape may be a circle, and the nanopattern may be implemented in a shape in which a slope is gradually increased from the vertex toward the bottom surface.

FIG. 7C is a diagram illustrating an implementation example of the refractive index buffer layer 132 using a nanopattern according to one or more embodiments.

For example, the nanopattern may be implemented with a nanopattern that forms a vertex from one surface and forms a bottom surface of a pre-set shape from other surface. As shown in FIG. 7C, the nanopattern may be implemented in a step shape in which a width (or size) of a cross-section is increased moving from the vertex to the bottom surface. Here, the shape of the bottom surface may include at least one from among a triangle, a quadrangle, or a circle.

According to one or more embodiments, referring to FIG. 7D, the refractive index buffer layer 132 may include the first refractive index buffer layer 132-1 provided on one surface of the transparent layer 131 and the second refractive index buffer layer 132-2 provided on the other surface of the transparent layer 131.

For example, the first refractive index buffer layer 132-1 may be implemented with a nanopattern that increases in density moving from one surface on which light is incident to other surface from which the incident light is output. The second refractive index buffer layer 132-2 may be implemented with a nanopattern that reduces in density moving from a first surface adjacent to the other surface of the transparent layer 131 to a second surface from which light is output. For example, the nanopattern may be implemented in any one shape from among the shapes shown in FIG. 7A to FIG. 7C. Alternatively, the nanopatterns from the first refractive index buffer layer 132-1 and the second refractive index buffer layer 132-2 may be implemented in different forms.

FIG. 8 is a diagram illustrating a reflectance improvement effect of a refractive index buffer layer according to one or more embodiments.

The graph shown in FIG. 8 is an example comparing reflectance of glass with reflectance of AR coating and reflectance of a refractive index buffer layer, respectively, and shows a difference for reflectance according to incident angle of light and each method. Typically, a cover glass in the ultra-short throw projector device is used tilted at an angle of about 40 degrees, and at this time, the maximum incident angle does not exceed 70 degrees in most cases. If the tilt of the cover glass is tilted closely to 0 degrees, the incident angle may increase and the maximum incident angle may even exceed 80 degrees. Because reflectance is significantly increased at the incident angle of greater than or equal to 70 degrees, the reflectance may be significantly lowered when using the refractive index buffer layer using nanopatterns.

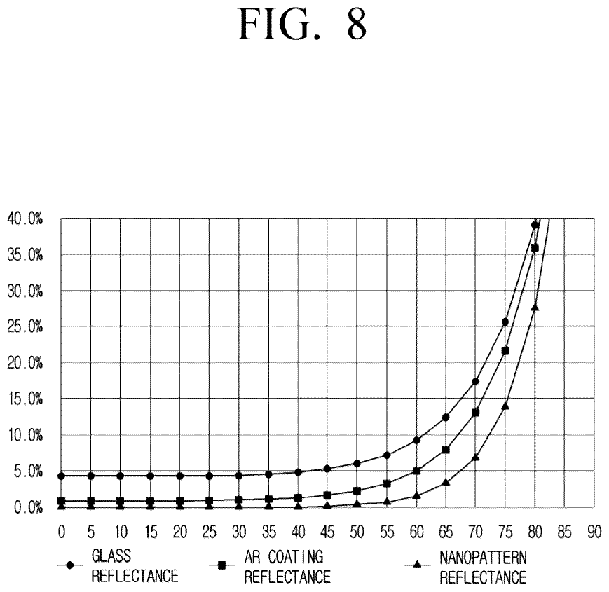

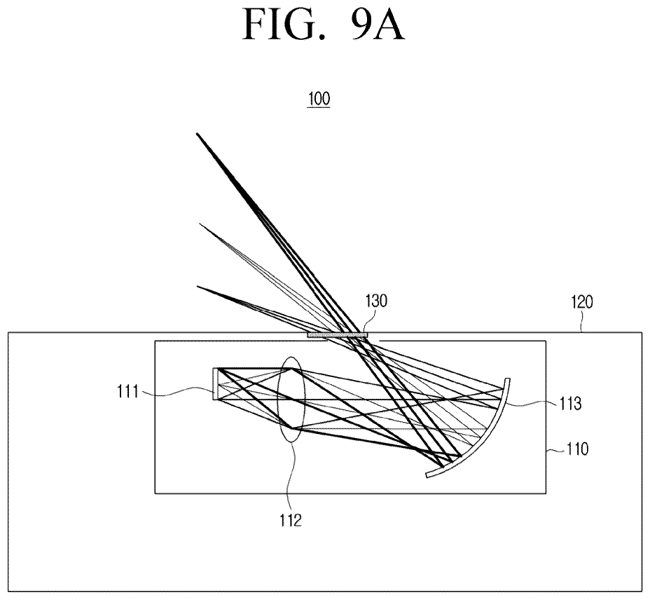

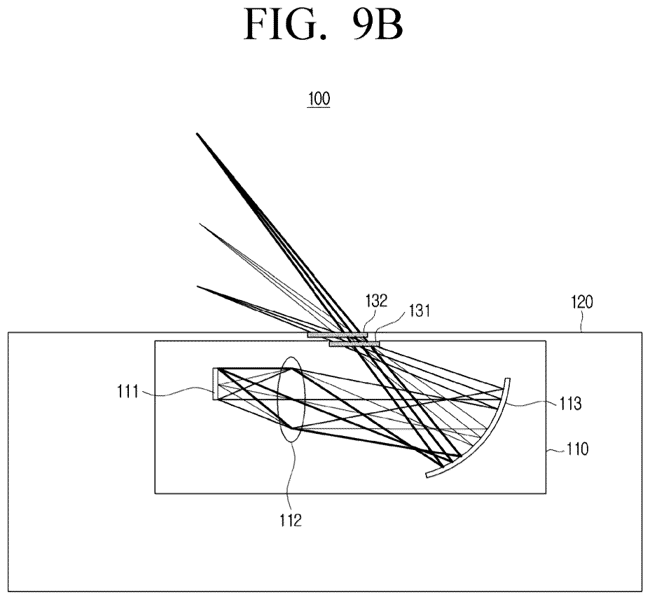

FIG. 9A and FIG. 9B are diagrams illustrating an arrangement form of a cover glass according to one or more embodiments.

According to one or more embodiments, as shown in FIG. 9A, the cover glass 130 may be provided at one side of the exterior case 120 corresponding to an area at which light from the optical module 110 is output. The cover glass 130 may be provided in parallel with one side of the exterior case 120.

For example, at one side of the optical module 110 corresponding to one side of the exterior case 120 provided with the cover glass 130, an opening may be provided. For example, the opening may be provided, as shown in FIG. 9A, at an area shifted by a certain distance in a direction light is incident from the cover glass 130, but is not limited thereto.

According to one or more embodiments, as shown in FIG. 9B, the cover glass 130 may include a first cover glass 131 provided at one side of the optical module 110 and a second cover glass 132 provided at one side of the exterior case corresponding to one side of the optical module 110. The first cover glass 131 and the second cover glass 132 may be provided in parallel with one side of the exterior case 120. That is, the first cover glass 131 and the second cover glass 132 may be provided parallel with each other.

In addition, the second cover glass 132 may be provided at a position shifted by a certain distance based on the first cover glass 131. For example, the second cover glass 132 may be provided at a position shifted by a certain distance in a direction light is incident from the first cover glass 131.

According to the various embodiments described above, brightness of a projector may be improved by reducing reflection from the cover glass of the projector device. In addition, by reducing reflectance of light having a large incident angle like the ultra-short throw projector device, uniformity in brightness may be improved. In addition, by reducing the reflectance of light having a large incident angle, exterior design of projector products may be improved by not tilting the angle of the cover glass when mounting the cover glass to the projector device or by minimizing the angle being tilted.

Respective elements (e.g., a module or a program) according to the various embodiments described above may be configured as a single entity or a plurality of entities, and a portion of sub-elements of the above-mentioned sub-elements may be omitted or other sub-elements may be further included in the various embodiments. Alternatively or additionally, a portion of the elements (e.g., modules or programs) may be integrated into one entity to perform the same or similar functions performed by the respective corresponding elements prior to integration. Operations performed by a module, a program, or other element, in accordance with the various embodiments, may be executed sequentially, in parallel, repetitively, or in a heuristically manner, or at least some operations may be performed in a different order, omitted, or a different operation may be added.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A projector device, comprising:
an optical module;
an exterior case comprising the optical module; and
a cover glass configured to transmit light incident from the optical module,
wherein the cover glass comprises:
a transparent layer comprising a transparent material; and
a refractive index buffer layer on at least one surface of the transparent layer, and
wherein a refractive index of the refractive index buffer layer changes with respect to a vertical direction.

2. The projector device of claim 1, wherein the refractive index buffer layer comprises a nanopattern that increases in density from a first surface to a second surface, and
wherein the refractive index consecutively changes from the first surface to the second surface.

3. The projector device of claim 2, wherein a total cross-sectional area of the nanopattern is increased moving from the first surface to the second surface.

4. The projector device of claim 2, wherein the nanopattern comprises a triangular pyramid shape or a square pyramid shape in which a vertex is at the first surface and a bottom surface is at the second surface.

5. The projector device of claim 2, wherein the nanopattern comprises a conical shape in which a vertex is at the first surface and the bottom surface is at the second surface, or
the nanopattern comprises a step shape in which a width of a cross-section is increased from the first surface to the second surface.

6. The projector device of claim 2, wherein the refractive index buffer layer is on a surface of the transparent layer on which light is incident from the optical module,
wherein the nanopattern increases in density from the first surface on which the light is incident to the second surface from which the incident light is output.

7. The projector device of claim 6, wherein the cover glass further comprises:
a coating layer on a second surface of the transparent layer, and
wherein the coating layer is an anti-reflection (AR) optical coating layer.

8. The projector device of claim 2, wherein the refractive index buffer layer comprises:
a first refractive index buffer layer on a first surface of the transparent layer; and
a second refractive index buffer layer on a second surface of the transparent layer,
wherein the first refractive index buffer layer comprises the nanopattern that increases in density from a first surface on which the light is incident to a second surface from which the incident light is output, and
wherein the second refractive index buffer layer comprises a nanopattern that decreases in density from a first surface that is adjacent to the second surface of the transparent layer to a second surface from which the light is output.

9. The projector device of claim 1, wherein the projector device comprises an ultra-short throw projector device in which an angle of light incident to the cover glass is greater than or equal to a threshold angle.

10. The projector device of claim 1, wherein the cover glass is at a side of the optical module to which light from the optical module is output, and
wherein an opening is provided at a side of the exterior case corresponding to the side of the optical module provided with the cover glass.

11. The projector device of claim 10, wherein the cover glass is parallel to the side of the exterior case.

12. The projector device of claim 1, wherein the cover glass is parallel to a side of the exterior case corresponding to an area to which light from the optical module is output, and
wherein an opening is provided at a side of the optical module corresponding to the side of the exterior case provided with the cover glass.

13. The projector device of claim 1, wherein the cover glass comprises:
a first cover glass provided at a side of the optical module; and
a second cover glass provided at a side of the exterior case corresponding to the side of the optical module.

14. The projector device of claim 13, wherein the first cover glass and the second cover glass are parallel to each other, and
wherein the second cover glass is at a position offset by a pre-set distance based on the first cover glass from the side of the exterior case.

15. The projector device of claim 1, wherein the optical module comprises:
a light panel comprising micromirrors integrated thereon;
a lens configured to refract and transmit light output from the light panel; and
an aspheric mirror configured to reflect the light refracted through the lens in a direction of the cover glass.
